(19) United States
(12) Patent Application Publication
(10) Pub. No.: US 2006/0090794 A1
(43) Pub. Date: May 4, 2006

(54) Water shut-off valve with integrated coupling for attaching cover plate

(76) Inventor: Aasef Shafik, Annandale, VA (US)

Correspondence Address: Dennis H. Lambert & Associates, 7000 View Park Drive, Burke, VA, 22015, US

(21) Appl. No.: 10/978,996

(22) Filed: Nov. 1, 2004

(51) Int. Cl. F16L 5/00

(52) U.S. Cl. 137/360

(57) ABSTRACT

A fluid control valve adapted to be positioned behind a wall or other surface having an access opening for gaining access to the valve, wherein a cover plate is secured against the surface in covering relationship to the access opening to conceal the opening and the valve. A mounting bracket is affixed to the valve, and has a pair of wings projecting from opposite sides of the valve. Threaded openings are formed in the wings for receiving threaded fasteners extended through the cover plate and access opening to hold the cover plate against the surface. A sealing ring is positioned between the cover plate and wall to seal the cover plate relative to the surface.

### TECHNICAL FIELD

This invention relates to water shut-off valves, and more particularly, to a water shut-off valve having an integrated coupling for attaching a cover plate.

### BACKGROUND ART

Shut-off valves, pressure regulating valves, and the like, typically are provided in water supply lines in the walls, floors, ceilings, or other surfaces of residential and commercial buildings to enable the water to be shut off for maintenance, or the pressure regulated, or the like. An access opening is provided through the wall or other surface of the building to enable a tool, handle, or the like to be engaged with the shut-off valve to operate it. A large cover plate normally is placed over the access opening to conceal the opening and valve until access to the valve is desired. Conventional practice is to secure these cover plates to the wall or other surface by extending screws or other suitable fasteners through the plate and into the wall or other surface. Not only is this arrangement unsightly, but walls typically are constructed of gypsum board, and floors typically are constructed of wood, concrete, or other material. Over time, the openings in the surface for receiving the fasteners become enlarged or damaged, whereby the fasteners no longer have a secure grip on the surface.

Thus, there is need for a cover plate for covering and concealing the access opening for a water shut-off valve in the wall or other surface of commercial and residential buildings, wherein the cover plate is attractive and the attachment for the cover plate is strong and durable.

### DISCLOSURE OF THE INVENTION

The invention comprises a valve for controlling the flow of fluid, and that normally is positioned in a wall or floor behind an access opening in the wall or floor, and has an integrated coupling for attaching a cover plate, thereby providing a stronger, more durable, and more decorative or attractive structure than conventional arrangements.

The valve of the invention has a valve body with a valve member movable therein, and an actuating stem projecting from the valve member for engagement with a tool to operate the valve member. In one example illustrated and described herein, the valve comprises a water shut-off valve and the actuating stem extends within a cylindrical sleeve attached to the valve body. In another example, the actuator stem is not shrouded in a sleeve, and a drain fitting is provided on the valve body for draining water from the valve housing. In both examples described herein, the end of the stem is slotted for engagement with a screwdriver, although it should be understood that other types of actuators may be employed.

In use, the valve is connected in a water supply line in a wall or other surface, and an access opening is formed through the surface to gain access to the valve to operate it. In accordance with the invention, a mounting bracket or coupling is affixed to the valve body, and a decorative cover plate is secured over the access opening by one or more screws or bolts or other suitable fasteners extended through the cover plate and through the access opening and connected with the bracket. In the specific example disclosed herein, the fasteners comprise threaded screws or bolts threadably engaged with the bracket, and in a preferred embodiment, a sealing ring or gasket is engaged between the cover plate and the wall surrounding the access opening to seal against leakage of water past the cover plate.

The cover plate of the invention is much smaller than the conventional cover plates normally used, and has a decorative, finished surface. It is therefore much more attractive than conventional cover plates, and also is much stronger and more durable.

Although shown herein as having a circular shape, the cover plate of the invention can have other shapes, and can be made of metal, plastic or other suitable material, including, but not limited to, brass, stainless steel, and the like.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a fragmentary, exploded front perspective view of a conventional cover plate arrangement.

FIG. 2 is a fragmentary front perspective view of the cover plate of FIG. 1, shown secured in place over the access opening.

FIG. 3 is an enlarged, exploded perspective view of a first form of water shut-off valve and cover plate assembly according to the invention.

FIG. 4 is an exploded side view in elevation, with parts shown in section, of the valve and cover plate assembly of FIG. 3.

FIG. 5 is a plan view, with portions shown in section, of the valve and cover plate assembly of FIGS. 3 and 4 shown in assembled relationship.

FIG. 6 is a reduced scale, fragmentary perspective view of the cover plate of the invention secured over the access opening in a wall to conceal the opening and valve positioned behind it.

FIG. 7 is a top perspective view of an alternate form of valve, wherein the actuating stem is not shrouded in a sleeve, and a drain fitting is provided on the valve body.

### DETAILED DESCRIPTION OF THE PREFERRED EMBODIMENT

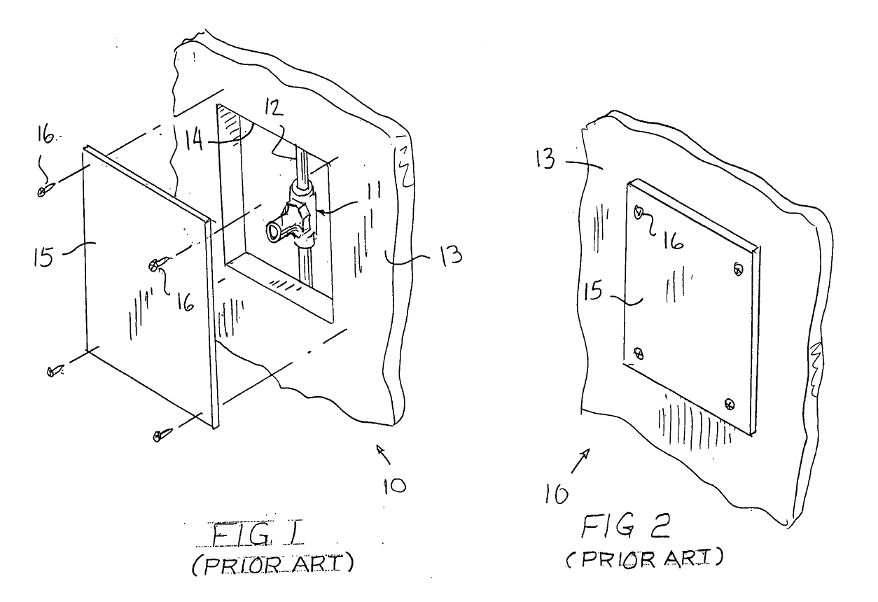

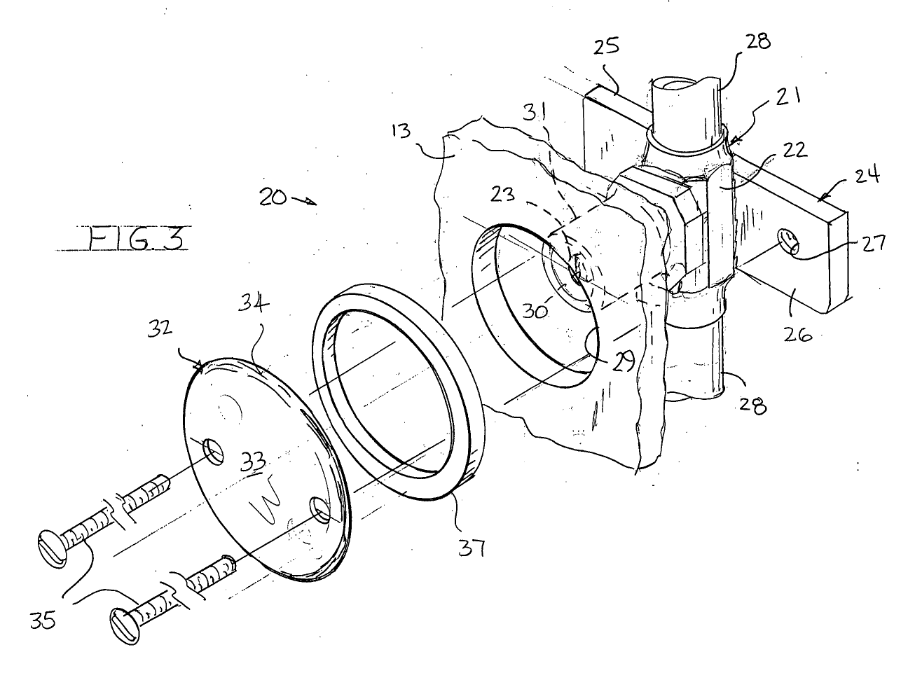

A conventional water shut-off valve and cover plate arrangement is shown at 10 in FIGS. 1 and 2. The shut-off valve 11 is connected in a water supply pipe 12 behind a wall 13, and an access opening 14 is formed through the wall to gain access to the valve. A cover plate 15 is then secured to the wall over the opening by extending fasteners such as screws or the like 16 through the plate and into the wall.

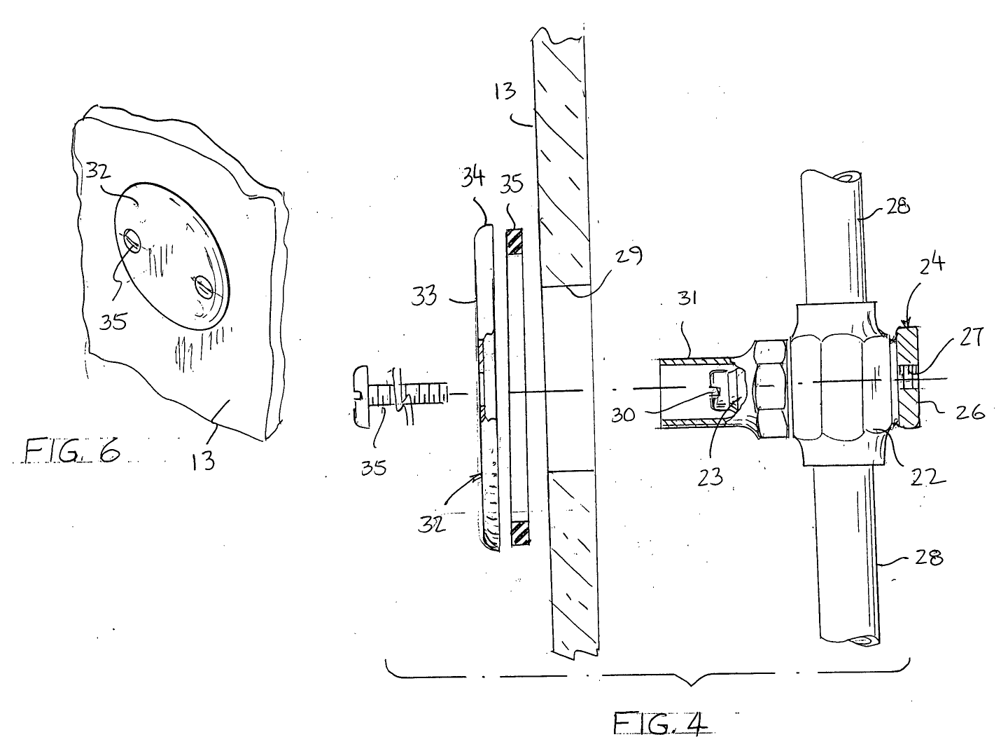

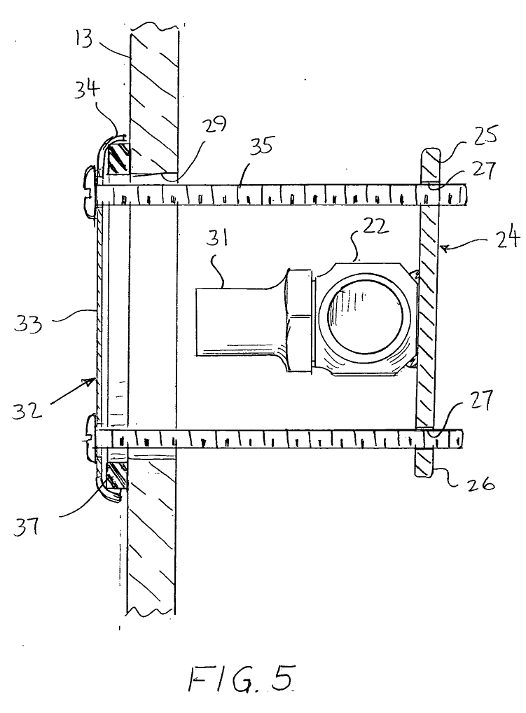

A first form of valve and cover plate arrangement of the invention is indicated generally at 20 in FIGS. 3-5. The valve 21 comprises a conventional water shut-off valve having a valve body 22 and an actuating stem 23 extending from one side. A coupling or mounting bracket 24 is affixed to the body on the side opposite the actuating stem 23. The bracket has wings 25 and 26 projecting from opposite sides of the valve body, and threaded openings 27 are formed in the wings. The bracket may be welded, brazed or otherwise retrofitted to a conventional valve body, or it may be made a part of the valve body during manufacture of the valve. The valve is conventionally connected in a water pipe 28 located behind a wall 13, and a circular access opening 29 is formed through the wall to gain access to the valve. The actuating stem 23 has a slotted end 30 for engagement by a screwdriver, and extends within a cylindrical sleeve 31 oriented toward the opening. A circular cover plate 32, slightly larger in diameter than the access opening 29, is secured against the wall over the opening to conceal the opening and the valve. The plate has a flat central portion 33 and a rounded annular peripheral skirt 34, and is secured in place by a pair of fasteners such as screws or bolts or the like 35 extended through openings 36 in the cover plate and through the access opening 29 into threaded engagement with the openings 27 in the mounting bracket 24. A sealing ring 37 made of rubber or other suitable material preferably is located between the plate and the wall, as seen in FIGS. 3, 4 and 5. As seen best in FIG. 5, the sealing ring has a diameter adapted to fit closely within the rounded annular skirt 34 of the cover plate, and a thickness such that the sealing ring holds the cover plate slightly spaced from the wall when the parts are operatively assembled.

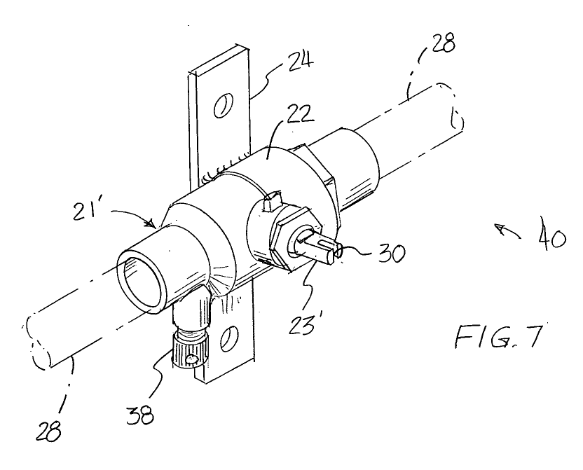

A second form of valve and cover plate mounting assembly is indicated generally at 40 in FIG. 7. Since the cover plate and its attaching screws are the same as in the previously described embodiment, they are not shown in this figure. This form of the invention is essentially the same as that previously described, except that the valve 21′ has a drain fitting 38 for draining water from the valve body, and the stem 23′ is not shrouded in a sleeve.

The valves with which the mounting bracket 24 is associated may be of any type, although the two valves shown are typically used for water shut-off. Valve 21 for instance may require many turns of the actuating stem to move it between open and closed positions, and valve 21′ may require only a quarter turn. Moreover, although the valves have been shown as having a slotted stem for operation by a screwdriver, the valves may be adapted instead for use with suitable handles.

The arrangement of the invention is much more attractive than conventional systems. In this regard, the cover plate can be made decorative and otherwise adapted to conform to a selected décor. It is also much stronger and more durable than conventional systems because of connection of the plate to the bracket on the valve body, rather than attachment to the wall as in conventional arrangements.

While particular embodiments of the invention have been illustrated and described in detail herein, it should be understood that various changes and modifications may be made to the invention without departing from the spirit and intent of the invention as defined by the scope of the appended claims.

What is claimed is:

1. A valve for controlling flow of fluid and adapted to be mounted behind a wall or other surface having an access opening therein for gaining access to the valve, said valve comprising:
a valve body; and
a mounting bracket affixed to the valve body, said mounting bracket having oppositely extending wings projecting outwardly beyond the valve body, and threaded openings formed in the wings for receiving fasteners extended through a cover plate and an access opening in a wall or other surface when the valve is positioned behind the surface.

2. A valve and cover plate assembly for mounting to a wall or other surface, wherein the valve is positioned behind the surface, an access opening is formed in the surface to gain access to the valve, and the cover plate is positioned on the surface in covering relationship to the access opening to conceal the opening and the valve, comprising:
a mounting bracket affixed to the valve, said mounting bracket having at least one threaded opening therein;
at least one opening formed through said cover plate; and
at least one fastener extended through said at least one opening in the cover plate and through the access opening into threaded engagement with said at least one threaded opening in the mounting bracket to securely hold the cover plate against the surface.

3. A valve and cover plate assembly as claimed in claim 2, wherein:
said mounting bracket has oppositely extending wings projecting outwardly beyond the valve, and said at least one threaded opening comprises a threaded opening in each wing;
said at least one opening through the cover plate comprises a pair of openings, with the openings located adjacent opposite sides of the cover plate; and
said at least one fastener comprises a pair of fasteners, with a fastener extended through each opening in the cover plate and into threaded engagement with the threaded openings in the wings of the mounting bracket.

4. A valve and cover plate assembly as claimed in claim 3, wherein:
said cover plate is circular and has a flat central portion and a rounded annular peripheral skirt.

5. A valve and cover plate assembly as claimed in claim 4, wherein:
an annular sealing ring is positioned between the cover plate and surface.

6. A valve and cover plate assembly as claimed in claim 5, wherein:
the sealing ring has a diameter to fit closely within the annular peripheral skirt of the cover plate.

7. A valve and cover plate assembly as claimed in claim 3, wherein:
an annular sealing ring is positioned between the cover plate and surface.
